(19) United States
(12) Patent Application Publication
(10) Pub. No.: US 2022/0346458 A1
(43) Pub. Date: Nov. 3, 2022

(54) Display Bar Graph and Adaptive Control

(71) Applicant: JT International SA, Geneva (CH)

(72) Inventor: Claude Zominy, Copponex (FR)

(73) Assignee: JT International SA, Geneva (CH)

(21) Appl. No.: 17/761,028

(22) PCT Filed: Sep. 18, 2020
(86) PCT No.: PCT/EP2020/076139

§ 371 Date: Mar. 16, 2022

(30) Foreign Application Priority Data
Sep. 18, 2019 (EP) 19198018.4

(51) Int. Cl. A24F 40/53; A24F 40/51; A24F 40/60

(52) U.S. Cl. CPC A24F 40/53; A24F 40/51; A24F 40/60

(57) ABSTRACT

A method of estimating and indicating a depletion level of the consumable in an aerosol generation device having a processor, a memory and a status indicator includes the step of generating and storing on the memory usage data on a usage of the aerosol generation device by a user. The usage data is read from the memory and a depletion level, preferably in remaining number of puffs on the consumable is calculated based on the usage data. The calculated depletion level of the consumable and/or whether the consumable has been consumed is signaled is signaled to the status indicator.

### CROSS-REFERENCE TO RELATED APPLICATIONS

The present application is a national phase entry under 35 U.S.C. § 371 of International Application No. PCT/EP202/076139, filed Sep. 18, 2020, published in English, which claims priority to European Application No. 19198018.4 filed Sep. 18, 2019, the disclosures of which are incorporated herein by reference.

### BACKGROUND OF THE INVENTION

The present invention relates to a method of estimating and indicating a depletion level of a consumable, control circuitry and an aerosol generation device having a processor, a memory and a status indicator.

The popularity and use of aerosol generation devices (also known as reduced-risk or modified-risk devices or vaporizers) has grown rapidly in the past few years as an aid to assist habitual smokers wishing to quit smoking traditional tobacco products such as cigarettes, cigars, cigarillos, and rolling tobacco. Various devices and systems are available that heat or agitate a carrier substance to produce an aerosol for inhalation, as opposed to burning tobacco as in conventional tobacco products.

One type of aerosol generation device is a heated substrate aerosol generation device, or heat-not-burn device. Devices of this type generate an aerosol by heating a solid aerosol substrate, typically moist leaf tobacco, to a temperature that may be in the range of 150° C. to 300° C. Another type an aerosol generation device is a liquid vaporization device. In liquid vaporization devices, a vaporizable substance may be held in a cartridge. The vaporizable substance may then be heated or otherwise agitated, for example by vibrations, such that an aerosolization is performed.

Heating an aerosol substrate, but not combusting or burning it, releases an aerosol that comprises the components sought by the user but not the toxic and carcinogenic byproducts of combustion. Furthermore, the aerosol produced by heating the aerosol substrate or the vaporizable substance, e.g. tobacco, do not typically comprise the burnt or bitter tastes resulting from combustion that can be unpleasant for the user. This means that the aerosol substrate does not require sugars or other additives that are typically added to the tobacco of conventional tobacco products to make the smoke more palatable for the user. However, in contrast to traditional cigarettes, a user cannot directly observe the depletion of the tobacco material in the aerosol generation devices.

U.S. Pat. No. 10,143,235 discloses an e-cigarette personal vaporizer. The e-cigarette personal vaporizer includes an atomizer and a puff counter. The personal vaporizer may include a series of 12 LEDs, that progressively light up as the personal vaporizer consumes nicotine equivalent to a single cigarette. According to U.S. Pat. No. 10,143,235 one LED lights up per inhalation, where the e-liquid strength used means that twelve inhalations correspond to smoking a single cigarette. Alternatively, a user can set the LEDs so that a single LED lights up when nicotine equivalent of an entire cigarette is consumed.

US 2015/0142387 A1 discloses a system for detecting, monitoring and logging smoking activity related data. The device comprises a housing, a power supply, an atomizer and a data logging device configured to be located within the housing. A microcontroller comprised by the data logging device processes the logging data. The logging data comprises data relating to the characteristics and conditions of the system, e.g. a heating element, a liquid storage area, an atomizer, a battery, and user activity log data. Based on the logging data, the microcontroller controls to the amount and timing of delivery of an aerosol payload to a user.

WO 2018/098371 A1 relates to a vapor inhalation system and to computerized methods for developing consumer specific models for efficacy for therapeutic and recreational use management based on dynamic modeling of consumer physiology, consumer experiential feedback, consumer use behavior, specific products and environmental factors. WO 2018/098371 A1 proposes to use a complex, multivariable sensing system to improve the overall efficacy of vaping products.

The prior art suffers from the disadvantage that a user cannot effectively monitor his aerosol-generating device while adjusting the device to his needs at the same time. It is thus the object of the present invention to provide a method, a control circuitry, and an aerosol generating device that allow a simple, intuitive handling while being flexibly adjustable to the user's habits, needs and usage.

### BRIEF SUMMARY OF THE INVENTION

A first aspect of the invention relates to a method of estimating and indicating a depletion level of the consumable in an aerosol generation device. The aerosol generation device has a processor, a memory and a status indicator. The method comprises the steps of generating and storing on the memory usage data on a usage of the aerosol generation device by a user. The usage data is read from the memory and a depletion level, preferably a remaining number of puffs on the consumable, is calculated based on the usage data. The calculated depletion level of the consumable and/or whether the consumable has been consumed is signaled to the status indicator. The usage data may comprise puff records and event records and the method may comprises the step of grouping the puff records in sessions based on the event records,

The consumable may include a portion of tobacco material. The portion of tobacco material comprises for example a crimped sheet or strips of reconstituted tobacco paper impregnated with a liquid aerosol former, or a liquid aerosol substrate.

The memory (sometimes referred to herein as data storage unit) may store usage data, in particular the puff records and/or event records. The data storage unit may comprise a volatile or non-volatile memory, e.g. a flash memory or solid-state memory or similar. The data storage unit may be suitable to store a number of puff records or event records. In one example, 6,000 or more puff records and 4,000 or more event records are storable on the data storage unit. The processor (e.g. a CPU) may retrieve all or part of the usage data stored in the data storage units to calculate a depletion signal based on the vaping behavior and preferences of the user, as will be explained in detail below.

The method has the advantage that the depletion level signaled to the status indicator is individualized and adjusted to the needs of a user. The depletion level can be calculated and forwarded to a user on an individual basis. According to the invention, depletion level is calculated based on usage behavior (i.e. usage data). Hence, the depletion level will be displayed according the habits of a user. The depletion level may let a user know, when a tobacco portion is depleted and must be changed.

For example, a high frequency of replacements of the consumable may indicate that a user desires a high dosage, while a low frequency of replacements of the consumable may indicate the user seeks to lower his nicotine intake.

Since the depletion level is calculated based on usage data rather than on a fixed function as in the prior art, it is more suited to the preferences of the users, improving their experience using the aerosol generating device. For example, some uses may prefer a strong taste which causes a faster depletion, while other users may want to keep their tobacco portion for a longer time. In an example of the invention, a user frequently performs vaping sessions, from that it is inferred that the user desires a stronger taste or more nicotine intake.

In a preferred embodiment of the first aspect, the depletion level is calculated in response to a detection of an insertion of a consumable.

In a preferred embodiment of the first aspect, the usage data comprises at least one of: a number of puffs per consumable, parameters on an airflow of puff(s), such as volume duration and/or strength, a frequency of puffs, a duration and/or frequency of sessions and the time of a session.

In a preferred embodiment of the first aspect, the usage data comprises puff records including at least one of: parameters on an airflow of a puff and a time stamp. The parameters on an airflow may include a presence of a puff, volume, duration and/or strength.

Further parameters of the usage data may be calculated from the puff records and used in the calculation. Examples of such parameters are an elapsed time since a previous puff(s), and a frequency of puffs in a session. In certain embodiments the puff records may additionally include environmental data, i.e. one or more of the following: a current temperature, a location, and weather.

In a preferred embodiment of the first aspect, the usage data comprises event records including at least one of: a type of event, a type of consumable, a consumable identification number, and a time stamp. The type of event may include an insertion of the consumable, a removal of the consumable, a depletion of the consumable, switching the aerosol generation device on (i.e. switching the device on), switching the aerosol generation device off, and an error message. Examples of error messages are heater malfunctions, (stick) holder malfunctions, empty battery, required cleaning of the heater.

Based on the records, further indicators such as a time between consecutive puffs, sessions, and other puffing style indicators can be calculated. A session may be understood as a time from activating the device and using the device until the device is switched off again.

In a preferred embodiment of the first aspect, the puff records are grouped into sessions based on the event records. In particular, the puff records with a time stamp between the time stamp of the event of switching on the aerosol generation device and the time stamp of the event of switching off the aerosol generation device may be grouped into a session. Usage data grouped in vaping sessions, in particular a recent or the current vaping session, may provide reliable information on current user behavior and preferences.

A time stamp may in particular include the time of day and/or the day of the week. In further examples the time stamp may include a month and a year. With the above usage data, a user behavior can be analyzed, and accurate individual depletion levels can be calculated based on the individual user behavior.

In a preferred embodiment of the first aspect, a profile for type of the inserted consumable is received and the number of remaining puffs is additionally calculated based on the type of inserted consumable.

In a preferred embodiment of the first aspect, the calculation of the depletion level is based on an average number of puffs on previous consumables. The average number of puffs on previous consumables may for example be obtained with the puff records using the time stamps of the event records indicating an insertion and removal of the consumable from the aerosol generation device.

In a preferred embodiment of the first aspect, the calculation of the depletion level uses a machine learning algorithm to calculate the depletion level.

In a preferred embodiment of the first aspect, the calculation of the depletion level is based on the current time, in particular the time of day, usage data on the immediately preceding session and/or usage data on the current session. For example, in the morning a puff may cause a faster depletion, since they are regularly deeper puffs then in the evening when the puffs may be less intense.

In a preferred embodiment of the first aspect, the calculation of the depletion level is based on a comparison of the usage data on the current session to usage data on an average session.

In a preferred embodiment of the first aspect, the depletion level is calculated or re-calculated based on usage data in response to and activation of the aerosol generation device, wherein the calculation or re-calculation is preferably based on a time and/or usage data on the immediately preceding session.

In a preferred embodiment of the first aspect, the depletion level is calculated or re-calculated based on the usage data periodically or in response to a detection of a puff.

The calculation or re-calculation preferably uses usage data on the current session and particularly preferred compares the usage data to the usage data on previous sessions.

In a preferred embodiment of the first aspect, usage data is generated with at least one of: a puff sensor, a consumable replacement detector, in particular an ejection sensor and/or an insertion sensor, a consumable detection unit for detecting an identification tag of the consumable, and a user input interface. The consumable replacement detector may—for example—be formed by a movable piston that is moved in response to the insertion of a consumable, an (end-)position sensor, a proximity sensor, a light sensor, or a switch.

A puff sensor detects a presence of a puff and may thus provide information on a length of a puff, a time of a puff (with a clock), and the parameters on an airflow of a puff. The puff sensor may provide usage data to the processor.

In a preferred embodiment of the first aspect, the depletion level is indicated to the user with a display, a speaker, or a vibrator. The display is preferably a bargraph. Thereby, a user may be informed graphically, audibly or haptically on the current depletion of the consumable. Of course, combinations of the above-mentioned means for status indication are possible.

In a preferred embodiment of the first aspect, the depletion level is indicated with a display with at least one light-emitting device. In a preferred embodiment, the display comprises two or more light-emitting devices that are even more preferably arranged in a linear arrangement. The light-emitting device may change its color based on the current depletion. For example, when a new consumable is inserted, the light-emitting device may display a green color, and subsequently change to a red color according to the current depletion level.

In a preferred embodiment, the display includes three, four, five or more light-emitting devices, in particular LEDs, wherein the light emitting devices are in a linear arrangement. A progression on the linear arrangement displays the adaptively calculated depletion level of the portion of tobacco material calculated by the processor to the user. In an example with two light-emitting devices, when the first light-emitting device lights up, half of the consumable is depleted and when the second light-emitting device lights up, the consumable is entirely depleted. Alternatively, the light-emitting device(s) may have any other suitable arrangement, such as a circle, along which a progression can be shown. Thereby, an intuitive and easy method for displaying the current depletion level to the user is provided.

A second aspect of the invention relates to a control circuitry comprising a processor and a memory. The control circuitry is configured to execute the method as described above.

A third aspect of the invention relates to an aerosol generation device having a processor and memory and a status indicator. The aerosol generation device is configured to perform the method as described above and to indicate the current depletion level of the consumable and/or whether the consumable has been consumed by means of the status indicator.

The aerosol generation device may be a heat not burn device (“T-Vapor”) or a liquid vaporizer (“E-Vapor”). Both, heat not burn products and/or liquid vaporizers, may be referred to as aerosol generation device within the scope of the present invention.

In a preferred embodiment, the aerosol generation device comprises an interface, which may be configured to receive the consumable, e.g. a heat stick or a cartridge comprising an e-liquid. Since it may be difficult or impossible for users to determine the depletion level of heat sticks or cartridges directly, the proposed calculation of a current depletion level is particularly advantageous for heat sticks and cartridges comprising e-liquids.

The parameters, e.g., insertion/replacement of consumable, time of day, detection of type consumable (nicotine, flavor), etc., may be used in connection with T-vapor and E-vapor devices in in a different or the same manner.

The parameters relating to the active heated time, while no puff is taken may be of particular relevance for the T—vapor device. One example may be a puff interval and/or a duration between two consecutive puffs. In T-vapor devices, a heater keeps working at a normal operation temperature during the entire vaping session, including the time between puffs. The tobacco portion may be heated in between puffs, and therefore may affect depletion of the consumable. Thus, the calculation may consider an active time of the heater and the time between puffs in particular for T-Vapor devices.

In E-vapor devices, a heater may be activated by the puff sensor and heat during puffs, but not in the absence of a puff. There is no heating between the puffs and the time between puffs may have little or no effect on the depletion level.

The consumable may include an identification tag, with a default number of remaining puffs as a basis for the calculation. In some embodiments, the device may include an interface for reading the data from the identification tag of the consumable. The default profile may allow the calculation to start with a remaining number of puffs closer to the users preferences when a particular type of consumable is inserted.

In a preferred embodiment, the default number of remaining puffs is based on a type of consumable. There may be different classes of consumables, e.g. consumables with different blends or consumables with additives, such as methanol, herbs, and fruit tastes, that a user may choose based on his personal preferences. The device may detect the class of consumable with the identification tag and adjust the default number of puffs accordingly. According to a particularly preferred option, a user may be able to set his preferred default level on the consumable, or on the device. In a further preferred embodiment, a user may provide a default number of puffs with an interface (e.g. one or more buttons).

### BRIEF DESCRIPTION OF THE DRAWINGS

In the following the invention is described in further detail with reference to the embodiments shown in the drawings in an exemplary manner, in which:

FIG. 1: is a schematic perspective view of an aerosol generation device according to a first embodiment, shown with a consumable being loaded into the aerosol generation device,

FIG. 2: is a schematic cross-sectional view from the side of the aerosol generation device and consumable of FIG. 1,

FIG. 3: is a schematic perspective view of a second embodiment of an aerosol generation device,

FIGS. 4a, 4b, 4c: are schematic views of a sequence of depletion levels during use of an aerosol generation device,

FIG. 5: is a schematic view of a sequence of events during use of an aerosol generation device,

FIG. 6: is a block diagram of components of an aerosol generation device,

FIG. 7: is a block diagram of a control circuitry comprised by the aerosol generation device,

FIG. 8: is a flow chart of an adaptive calculation of the depletion level upon insertion of a consumable,

FIG. 9: is a flow chart of an adaptive calculation of the depletion level upon initiating a new vaping session,

FIG. 10: is a flow chart of an adaptive calculation of the depletion level during a vaping session,

FIGS. 11A and 11B: are schematic views of a first embodiment of an insertion/ejection sensor,

FIGS. 11C and 11D: are schematic views of a second embodiment of an insertion/ejection sensor, and

FIGS. 12A to C: are schematic views of a third embodiment of an insertion/ejection sensor.

### DETAILED DESCRIPTION

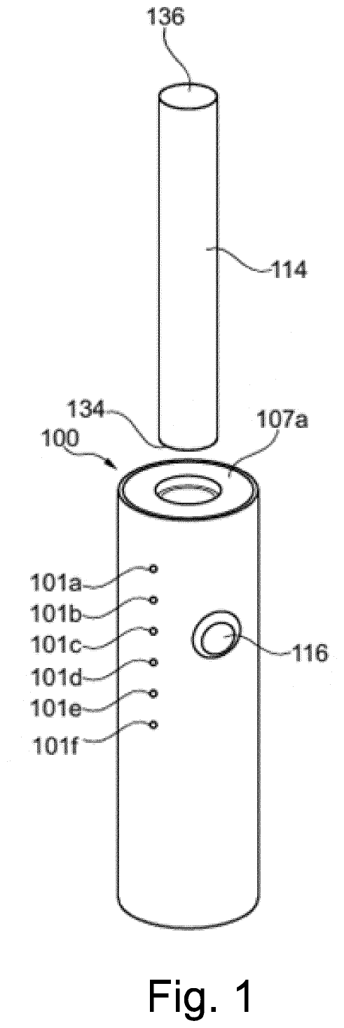

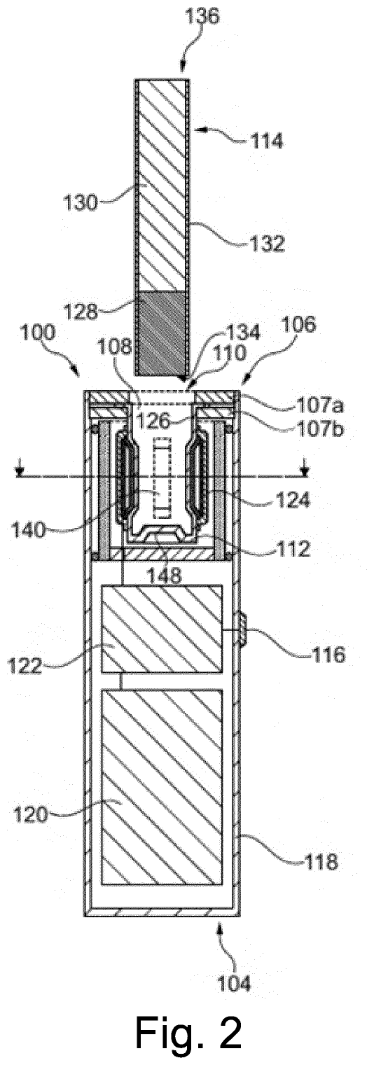

FIGS. 1 and 2 show an aerosol generation device wo and a consumable realized as substrate carrier 114. The aerosol generation device 100 comprises a body 118 that houses various components of the aerosol generation device 100. As shown in FIGS. 1 and 2, the body 118 is tubular and cylindrical. Note that the body 118 does not need to have a tubular or cylindrical shape but can have any shape as long as it is sized to fit the components described in the various embodiments set out herein. The body 118 can be formed of any suitable materials or layers of material. For example, an outer casing of the body 118 can be formed of an inner layer made of metal and an outer layer made of plastic. This allows the body 118 to be pleasant for user to hold.

The body 118 comprises a first end 104 and a second end 106. During use, the user typically orients the aerosol generation device 100 such that the first end 104 is downward and/or in a distal position with respect to the user's mouth and the second end 106 upward and/or in a proximate position with respect to the user's mouth. The second end 106 holds a pair of washers 107a, 107b (see cross-section of FIG. 2) by an interference fit with an inner portion of the body 118. The aerosol generation device 100 includes an interface for receiving the substrate carrier 114, wherein the interface is realized as heating chamber 108 located towards the second end 106 of the aerosol generation device 100. The heating chamber 108 is open towards the second end 106 of the aerosol generation device 100 and can receive the substrate carrier 114 within the heating chamber 108.

Further, the device 100 has a user-operable button 116. The button 116 is located on the body 118. The button 116 is arranged so that on actuating, for example by depressing the button, the user can activate the aerosol generation device 100 and commence a vaping session. Upon activation, the substrate carrier 114 may be heated to generate an aerosol for inhalation. On a side wall of the body 118, the device 100 further includes a status indicator realized as a display 101 comprising light-emitting devices 101a to 101f. The light-emitting devices 101a-f are arranged linearly along an axis of the body 118.

The heating chamber io8 (see FIG. 2) includes an open end 110, a side wall 126 and a base 112. A plurality of protrusions 140 are formed on the inner surface of the side wall 126. The protrusions 140 extend towards and engage the substrate carrier 114.

In the embodiment shown in the figures, the aerosol generation device 100 is electrically powered. An aerosol is generated with the aerosol generation device 100 using electrical power. The aerosol generation device 100 has an electrical power source 120, for example a battery. The power source 120 is coupled to control circuitry 122 that is operably connected to a heater 124. The user-operable button is arranged to couple the power source 122 and the heater 124 upon actuation via the control circuitry 122. Further, the control circuitry 122 controls the light-emitting devices 101a-f.

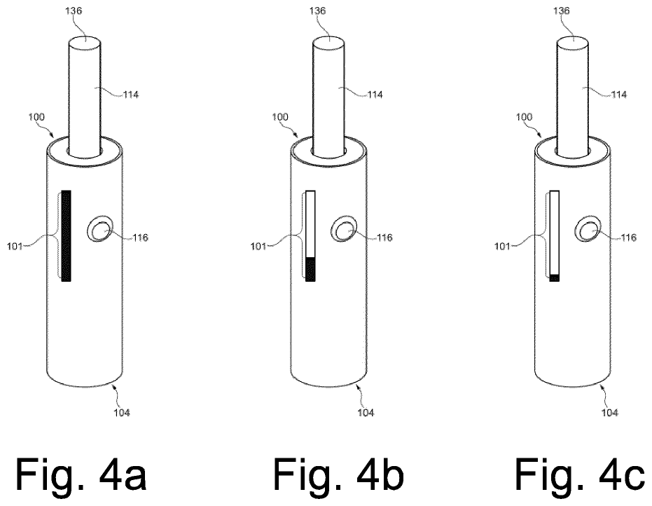

The substrate carrier 114 shown in FIGS. 1 and 2 in conjunction with the aerosol generating device 100 includes a first end 134 and a second end 136. The carrier 114 includes a portion of tobacco. In the case of the carrier 114, the portion tobacco is an aerosol substrate 128 (see FIG. 4) that is arranged towards the first end 134 and a vapor collection part 130 that is arranged towards the second end 136. Both, the vapor collection part 130 and the aerosol substrate 128 are held by a wrapper 132.

The aerosol substrate and substrate carrier 114 may be referred to as a consumable or consumable item. In the illustrated embodiment, the consumable item may be in the form of a rod that contains processed tobacco material, e.g. a crimped sheet or oriented strips of Reconstituted Tobacco (RTB) paper impregnated with a liquid aerosol former.

A user inserts the substrate carrier 114 beginning with the first end 134 into the heating chamber 108 until the first end 134 touches the base 112. In this position, the heater 124 is operable to heat the substrate 128, such that an aerosol is generated. The aerosol generation device 100 includes an end position sensor (e.g. a piston, not shown) to detect the insertion and removal of the substrate carrier 114.

The user activates the device 100 by pushing the button 116 that controls the control circuitry 122 and the power source 122 such that electrical power is supplied to the electrical heater 124. The button 116 may include a light or lights (for example one or more LEDs or other suitable light sources) to indicate the current status of the aerosol generation device 100. The status may mean one or more of the following: battery power remaining, depletion level, heater status (in particular on, off, error etc.), device status (for example ready to take puff) or other indication of status, for example error modes.

The user may insert the carrier 114 into the heating chamber 108. When the carrier 114 is inserted, the movable piston (not shown) may be moved in response to the insertion of the carrier 114 and send an insertion signal to the processor. Alternatively or additionally, the device 100 may include a different sensor for detecting the carrier 114, such as a position sensor, a proximity sensor, a light sensor, or a switch. The control circuitry may detect the signal from the sensor and may generate an event record, i.e. the insertion of a carrier 114. On the other hand, when the carrier 114 is removed, the control circuitry may detect a second signal from the sensor and may generate a second event record, i.e. the removal of the carrier 114. The event records are stored on the data storage unit such that they may be processed immediately or later.

The control circuitry 122 may be configured to count puffs. A single inhalation by a user may be referred to as a “puff”. The control circuitry 122 may be configured to count puffs, i.e. by receiving a signal from a puff sensor. In some embodiments, the device determines the presence of a puff with a temperature sensor. The temperature decreases during a puff because fresh, cool air flows past the temperature sensor, and thus a drop in temperature may indicate a puff. In other embodiments, the control circuitry may determine an airflow through the device 100 or through the aerosol generating substrate 128 with an airflow sensor (not shown).

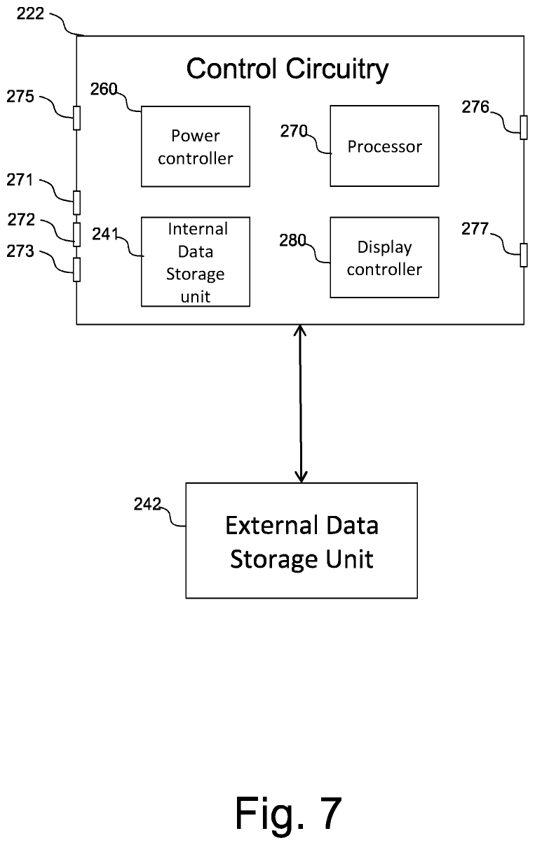

The control circuitry 122 includes a processor 270 as shown in FIG. 7. The processor 270 controls the display 101 with light-emitting devices 101a-f (and/or additional lights emitting devices in a button 116 in a similar fashion). The display 101 displays a current depletion level of the substrate carrier 114 to the user.

For example, the substrate carrier may allow 6o puffs. In the example shown in FIGS. 1 and 2, the display 101 includes 6 light-emitting devices 101a-f. Hence, after the first ten puffs, the first light-emitting device 101a is activated. After ten further puffs, the second light-emitting device 101b is activated, while the first light-emitting device 101a may or may not stay activated. After the entire 60 puffs have been consumed, the last light-emitting device 101f is activated, which indicates to the user that the aerosol substrate 128 of the substrate carrier 114 is depleted and that the substrate carrier 114 needs to be replaced.

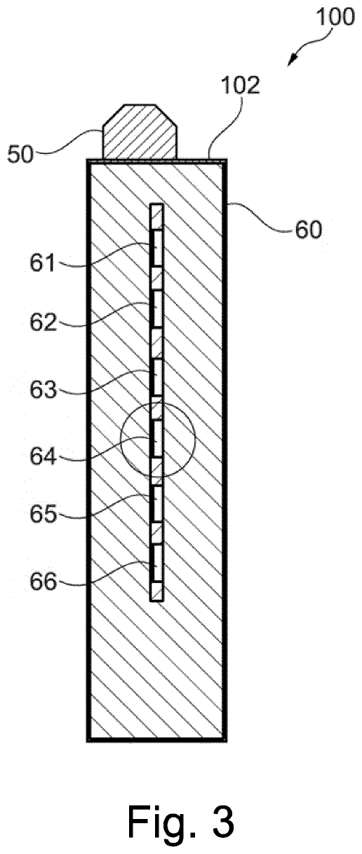

A schematic view of a second embodiment of an aerosol generating device 100 with a mouthpiece 50 and a display 60 is shown in FIG. 3. The aerosol generating device 100 includes a body 118 with a bargraph 60. The bargraph 60 includes elongated sections 61 to 66, each of which comprises an LED. One of the sections (section 64) is activated. This indicates that i.e. 50% of the tobacco portion (3 out of 6) is depleted. The elongated sections 61 to 66 are spaced apart. Advantageously, the elongated sections 61 to 66 may also be arranged directly next to each other.

A schematic view of a third embodiment of the light-emitting device 101 is shown in FIGS. 4a, 4b and 4c. In the third embodiment, the status indicator is realized as a display 101, that shows a bar with decreasing length as the consumable is consumed. In 30 FIG. 4a, the substrate carrier 114 was just inserted and the status indicator shows that no depletion has occurred. In FIG. 4b, approximately 50% of the substrate carrier is depleted, while in FIG. 4c, the substrate carrier is depleted by 95%. The continuous display 101 shown in FIGS. 4a, 4b and 4c allows a fine-tuning of the depletion levels.

In order to improve a user experience, the device 100 may have different profiles stored internally. In a first mode, a preprogrammed mode, the device includes a data storage, realized as an electronic memory that may be part of the control circuitry 122, on which different profiles are stored internally. A first profile (“strong strength”) corresponds to a strong strength. In this profile, first light-emitting device 101a in figure flights up after the first five puffs. The second light emitting device 101b then lights up, when the number of puffs is equal to 10. Depletion is thus already reached after 30 puffs (6 light-emitting devices times 5 puffs). This profile may be particularly advantageous for users that take deep and long puffs, which lead to a fast depletion of the substrate carrier 114.

A second profile (“mild strength”) that might be selected transitions from one light-emitting device (e.g. light-emitting device 101a) to the next light meeting device (e.g. light-emitting device 101b) after 8 puffs. In this profile, the substrate carrier is depleted after 48 puffs. A third profile (“soft strength”) may be suitable for users that draw only shortly and/or lightly on the device during each puff. In the third profile, a transition from one light-emitting device to the next light-emitting device is done after 12 puffs. A user may switch between profiles by pressing on a button (e.g. button 116).

Alternatively or additionally, the number of puffs between a transition might be determined by the substrate carrier. For example, each substrate carrier 114 may include an identification tag, e.g. an RFID tag, a barcode, or any information on the substrate carrier that can be read out by the device 100. The substrate carrier or other consumables (in particular cartridges with a liquid aerosol generating substrate) may include an electronic memory as identification tag. After reading out the information from the identification tag, the control circuitry 122 of the device 100 switches to the appropriate profile. The consumables may—for example—have different amounts of nicotine or flavors. Through the profiles, the depletion level may be adjusted to a particular type of consumable.

In a second mode, an adaptive mode, the device can be individualized to the needs of a user. In the second mode, rather than using a fixed, rigid progression for each consumable or each type of consumable as in the first mode, the progression between the light-emitting devices 101 is calculated adaptively based on a user's behavior. The puff sensor counts the number of puffs performed on each inserted consumable, which provides information about when the customer considers the portion is depleted for him individually. According to this information, the progression of the display 101 is calculated. For example, if a user exchanges the substrate carriers 114 regularly or on average after 54 puffs, a transition from one light-emitting device to the next light emitting device may occur after 9 puffs.

In this mode, the device detects the introduction of a new consumable and keeps track of a counter CT₁. When a new consumable is inserted, the processor resets the counter CT₁ to zero. When the device is activated, the device monitors the puffs and counts them, which causes CT₁ to be incremented accordingly (i.e. by one for each puff). When the device is switched off, the number of puffs is memorized in a data storage unit.

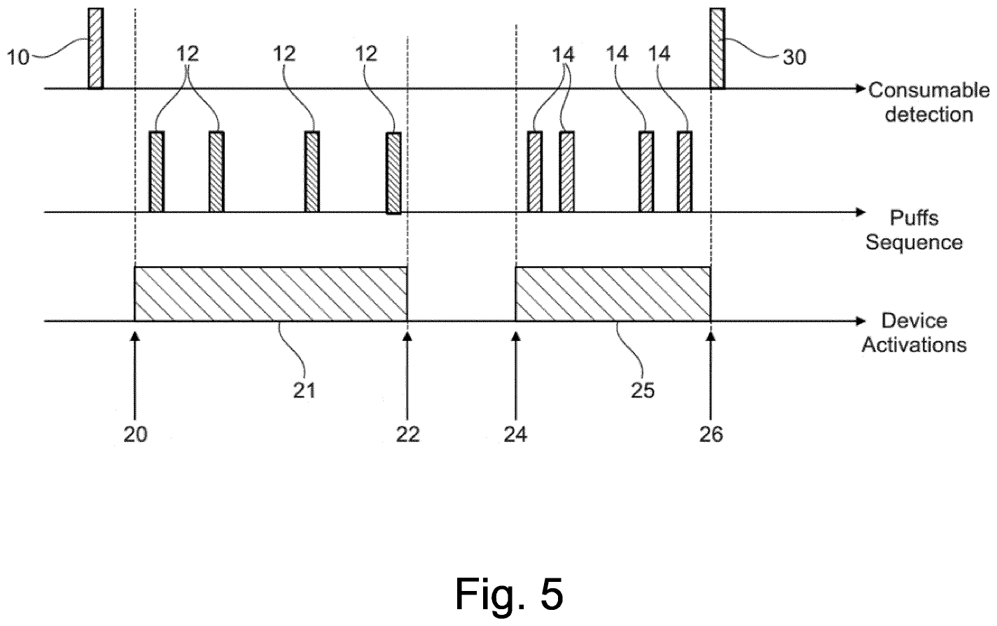

One simplified example of this procedure is shown in FIG. 5. FIG. 5 shows different events that may occur in a time frame beginning with an insertion of a new consumable and ending with an ejection of the consumable. A first timeline (see top of FIG. 5, “consumable detection”) indicates the detection of an insertion and ejection of the consumable. A second timeline (see center of FIG. 5, “puffs sequence”) indicates puffs drawn by a user, and a third timeline (see bottom of FIG. 5) indicates periods in which the device 100 is switched on (“vaping sessions”).

The device 100 detects the insertion 10 of a consumable. Then the device 100 is activated at time 20 until the user switches the device off at time 22. During this first vaping session 21, the user takes four puffs 12. The device 100 memorizes the 4 puffs in an electronic memory. At a later, third time 24, the user reactivates the device and initiates a second vaping session 25. In the second session 25, the user takes four puffs 14 before switching the device off again. Thereafter, an ejection 30 of the consumable is detected.

In total the user has taken 8 puffs during the use of the consumable, before he considered the consumable to be depleted. When the next consumable is inserted, the device may display a depletion level according to the information gathered in the session shown in FIG. 5. For example, after a first puff, the first part of the display, light-emitting device 101a, lights up; after a third puff, the second part of the display 101, light-emitting device 101b lights up, and so forth. The status indicator (display 101) shows a depletion level according to a consumption of the user in a previous session.

Additionally, the processor may compare the number of puffs taken while consuming the previous consumable to further historical data, i.e. a number of puffs on further consumables that were consumed. The processor may run an algorithm to adjust and determine the number of puffs that is usually drawn on such consumables. This algorithm may include an average or a more sophisticated statistical analysis, such as machine learning, including neural networks.

The present invention is not limited to counting a total number of puffs during the use of a consumable. In a similar manner, a frequency of puffs and a length of the vaping sessions 21 and 25 or any other usage data mentioned herein may be considered. In one example the consumer is performing continuous vaping sessions more frequently than usual, which may indicate that he desires to have more or a stronger taste or nicotine intake. Accordingly, a total consumption over a single consumable may be reduced to 16 puffs, instead of the usual 20 puffs of a user.

In another example, with a new consumable the consumer is taking a puff every 15 seconds, while on previous consumables he had taken a puff every 30 seconds, which may also indicate a desire for a stronger taste or nicotine intake. In a similar fashion, the total consumption can be reduced to from 20 to 16 puffs by calculating the depletion level accordingly.

Further, the device 100 may include a clock that records the time of the day and the vaping behavior of the user during this time of the day. For example, in the morning a user may initiate short vaping sessions with frequent puffs while in the afternoon the same user initiates long vaping sessions with infrequent puffs. In this case, the consumable is depleted faster in the morning, while in the afternoon the depletion is slower.

The processor may reset the status indicator each time to 0% (i.e. 0% is consumed, none of the light-emitting devices are lit) or 100% (hundred percent left for consumption, all of the light emitting devices are lit or the last light-emitting device is lit). Although FIGS. 1 to 4c show a progression of light-emitting devices 101a-f (in io particular LEDs) in a linear form of or a bargraph, the invention is not limited to such status indicators. Additionally or alternatively, the device may include a display showing a numerical value, a circle of light-emitting devices, or a bargraph with any number of light-emitting devices. A depletion level may be shown as a progression along a graph, in particular a bargraph or a circular graph, a number, a frequency of blinking, a color, or any combination thereof. For example, the light emitting device 101a may emit green light while the light emitting device 101c may emit orange light and the light emitting device 101f may emit red light.

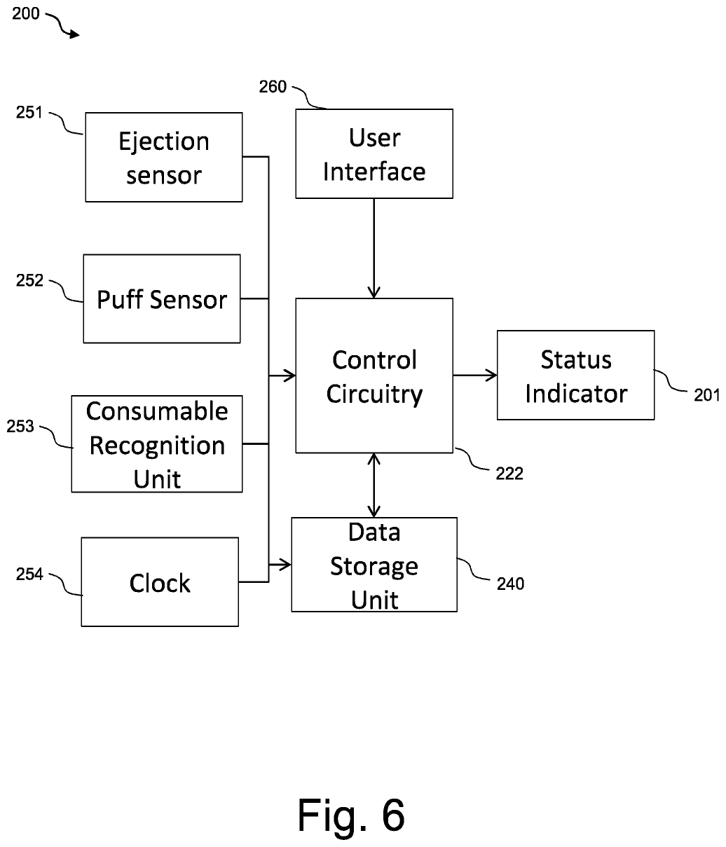

FIG. 6 shows a block diagram of an aerosol generation device 200, e.g. the aerosol generation devices 100 shown in one of the FIGS. 1 to 4c. However, the units shown in the block diagram of FIG. 6 may also be implemented in other aerosol generation devices, such as devices based on an e-liquid. The aerosol generation device 200 includes a control circuitry 222 that sends a depletion signal to a status indicator 201 that reports the depletion level to a user.

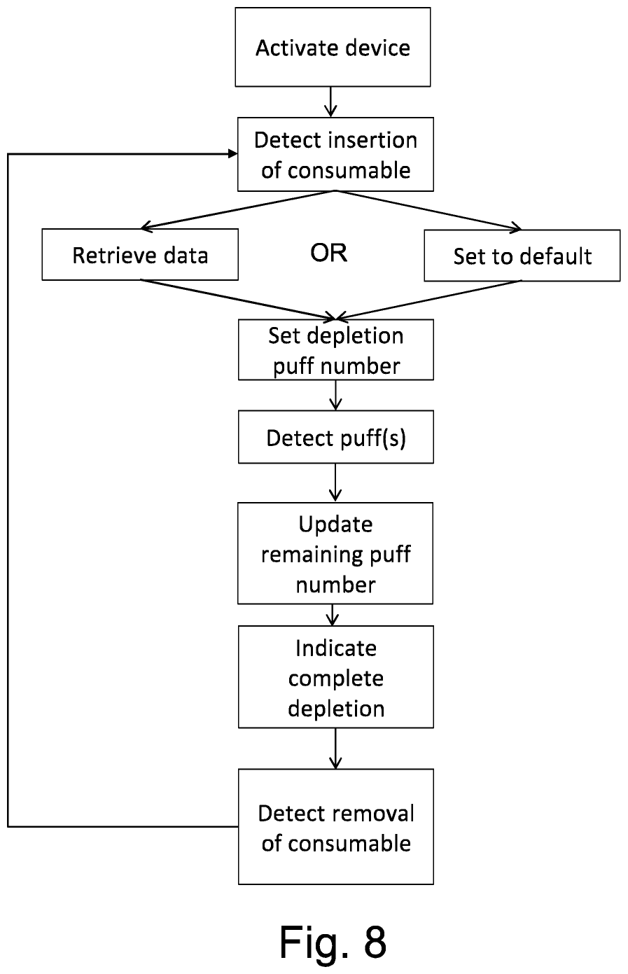

The control circuitry gathers data from usage data sensors 251 to 253 and a clock 254 and calculates the depletion level based on the data. Any data received by the control circuitry may be saved in a data storage unit 240. The data gathered from usage sensors 251 to 253 may also be directly stored in the data storage unit. The data storage may comprise a depletion profile for each inserted consumable based on the usage data collected from sensors 251 to 253. Such depletion profile can be analyzed at a later stage to estimate a depletion level adaptively (see in particular FIGS. 8 to 10).

The data is gathered from an ejection sensor 251, a puff sensor 252, a consumable recognition unit 253 and a clock 254. The ejection sensor 251 is used to detect ejection or removal of a consumable from the device. The consumable recognition unit 253 is configured to identify the inserted consumable and retrieve/read data indicating nicotine level, flavor or other related properties of the consumable.

The aerosol generation device 200 may comprise a user interface 26o. The user interface may receive user input for set-up, and/or switch between a default calculation of the depletion signal and an adaptive calculation of the depletion signal. Further, the user interface may receive user input to manipulate the depletion level or the calculation thereof.

The aerosol generation device 200 may comprise further sensors, such as a temperature sensor adapted to measure an outside temperature or a temperature of a heater of the aerosol generation device 200, an inertial motion sensor, or an inclination sensor. The data of the further sensors may also be considered in the adaptive calculation of the user behavior.

When the ejection sensor sends a signal to the control circuitry, indicating that a consumable is inserted to or ejected from the aerosol generation device, the control circuitry generates an event record with an entry that includes the insertion or injection of the consumable and the time at which the consumable was inserted. Additionally, the control circuitry may calculate a time between the previous insertion/ejection and add the result to the event record. Thereafter, the consumable recognition unit 253 may detect an identity tag, such as an RFID tag or an electronic memory, and read the identity data contained thereon. The identity data may be added to the event record, or a separate additional event record may be added. For example, the control circuitry may have generated an event record with the following entries: time: Thursday, May 8, 2019, 20:15; insertion of a new cartridge; cartridge type “strong”. The data storage unit 240 may include further data on the particular detected cartridge type, such as nicotine concentration, particular aromas or suitable temperatures for the heater. Alternatively, such further data may be contained in the identity data.

When a user draws on the cigarette, the puff sensor 252 detects a puff, and the control circuitry adds a puff record. Similar to the event record, a time measured by the clock 254 may be added to the puff record. Additional data may be added to the puff record depending on the sensor data. For example, the puff sensor may detect and measure airflow, from which a puff volume can be calculated by the control circuitry or the puff sensor itself. The control circuitry may calculate further entries for the puff record. In particular, the control circuitry may calculate a time between a previous puff and the current puff, group a series of puffs together to a vaping session and link the puff record to any previous event record or entries thereof. The puffs may be grouped into sessions based on phases in which the device is switched on, and/or otherwise. The control circuitry may store all event and puff records on a data storage unit 240 and access the data storage unit 240 to read out event and puff records for the adaptive calculation.

FIG. 7 shows the control circuitry 222 in detail. The control circuitry comprises a processor 270, a power controller 260, a display controller 280, and an internal data storage unit 241. The data storage unit 240 shown in FIG. 6 may be realized as the internal data storage unit 241 or as an external data storage unit 242, in which all records may be saved. The control circuitry may comprise input interfaces 271 to 273, to which the various sensors, user interfaces and units as e.g. shown in FIG. 6 may be connected. Further, the control circuitry includes a connection 275 to a battery and a connection 276 to the heater. The heater is controlled by the power controller 260. Any data obtained by the control circuitry 222 may be saved in the internal data storage unit 241, comprised by the control circuitry 222 or the external data storage unit 242. Further, the control circuitry comprises an interface 277 for sending depletion signals to the status indicator 201.

The adaptive calculation of a depletion level is shown in further detail in the flowcharts of FIGS. 8 to 10. FIG. 8 shows an adaptive calculation of a depletion level upon the insertion of a new consumable. First, the device is activated. After activation, a user may insert a new consumable. The previously mentioned ejection sensor may detect the insertion of the consumable and send a respective signal to the control circuitry. The control circuitry may then use a default or retrieve further data, such as event records of previously inserted and ejected consumables and previous puff records. Based on the puff records, event records and the current time of day the control circuitry may calculate and set a remaining puff number, e.g. 30 puffs until the inserted consumable is depleted, and show the current depletion level (e.g. 100% or 30 puffs until depletion) to the user. Whenever a puff is detected by the puff sensor, the remaining puff number is updated, until the consumable is depleted. Then, the ejection sensor may detect a removal of the consumable. Upon a subsequent insertion of a new consumable the control circuitry may re-calculate the depletion puff number based on the retrieved data of the previous smoking session and set the depletion puff number to the same or a different number. For example, the user may have taken quick and deep draws indicating a high intake and a quick depletion, which may lead to the control circuitry setting the depletion puff number lower for the following consumable (e.g. 28 or 27 puffs until depletion).

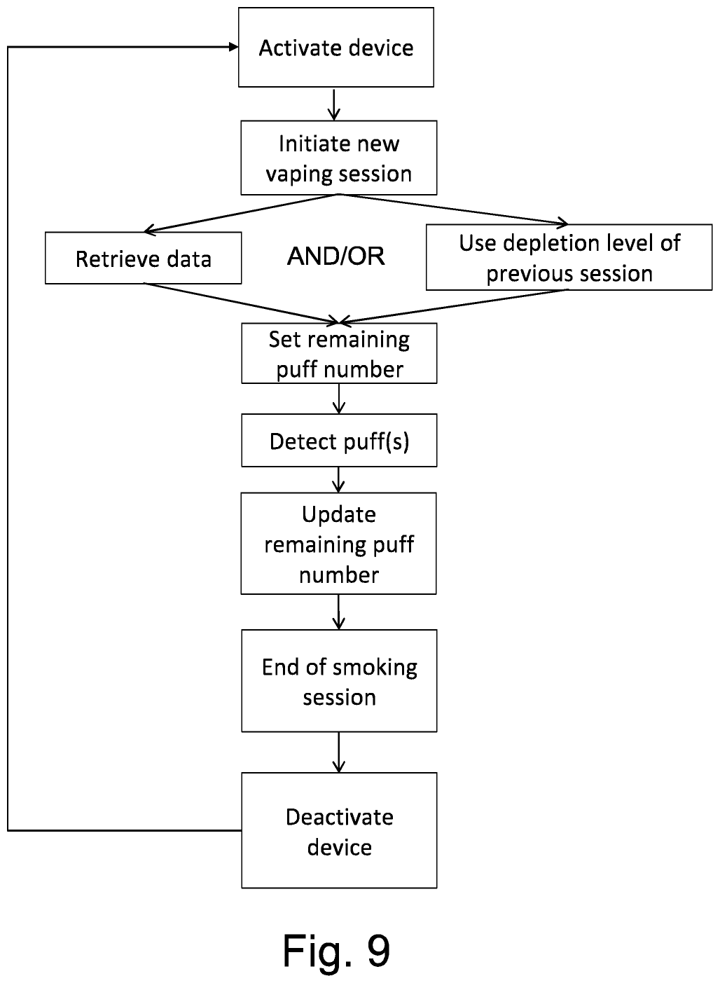

FIG. 9 shows a flowchart of another adaptive calculation of a depletion level. In FIG. 9, the adaptive calculation of the remaining puff number is triggered by the initiation of a new vaping session. When the user activates the device, a new session is initiated. The initiation of a new vaping session differs from the insertion of a new consumable in that a previously inserted and partly depleted consumable is continued to be used. Accordingly, the remaining number of puffs/ depletion level starts at a lower value.

When the new session is initiated, the control circuitry may simply use the depletion level calculated for the previous session, or it may calculate an updated depletion level, e.g. based on the depletion measured during the previous session. For example, the control circuitry may detect that it is now evening, while the previous session was in the morning, and re-calculate depletion level. Generally, the remaining number of puffs (i.e. the depletion level) is calculated similarly to the above example in FIG. 8, as outlined above and the depletion level is shown to the user.

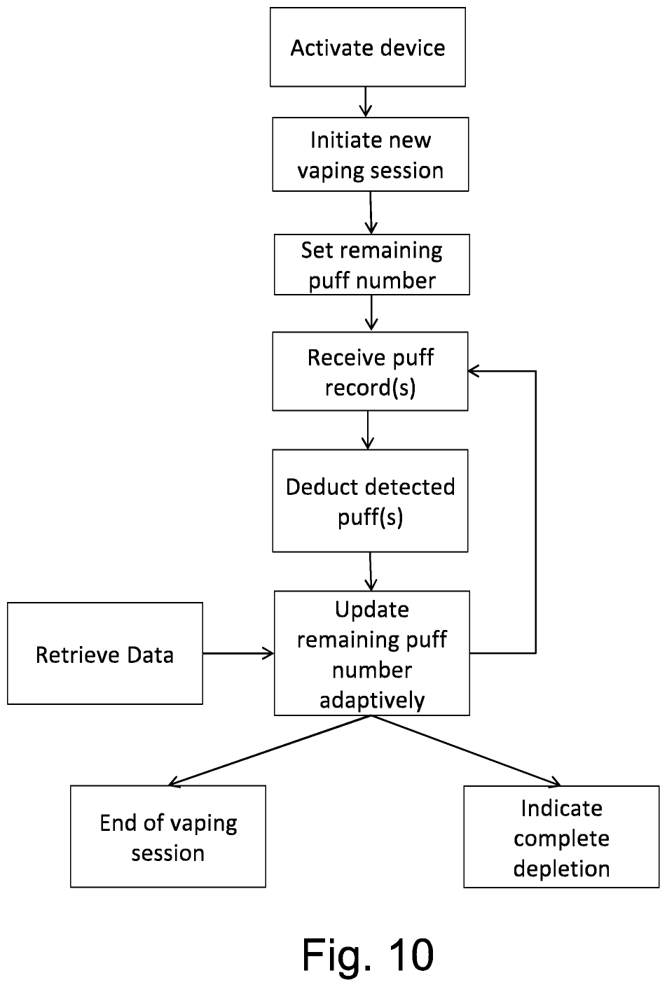

FIG. 10 shows another adaptive calculation. In the embodiment of FIG. 10, the adaptive calculation is triggered each time a puff is detected by the puff sensor. When the control circuitry generates a new puff record, a puff is deducted from the remaining number of puffs. The control circuitry retrieves data, as mentioned above, and calculates the remaining number of puffs by additionally considering the (previous) behavior of the user as indicated by the retrieved data.

In the above embodiments, the data may be retrieved from the data storage or directly sent to the processor and used in the calculation.

The adaptive calculations shown in FIGS. 8 to 10 may be used separately or in any combination. Preferably all adaptive calculations shown in FIGS. 8 to 10 are used at the same time. In the above examples, the adaptive calculation of the depletion level is triggered by an event such as switching the device on, inserting a consumable, or a puff. The adaptive calculation need not be triggered and can also be continuously updated at set time frames.

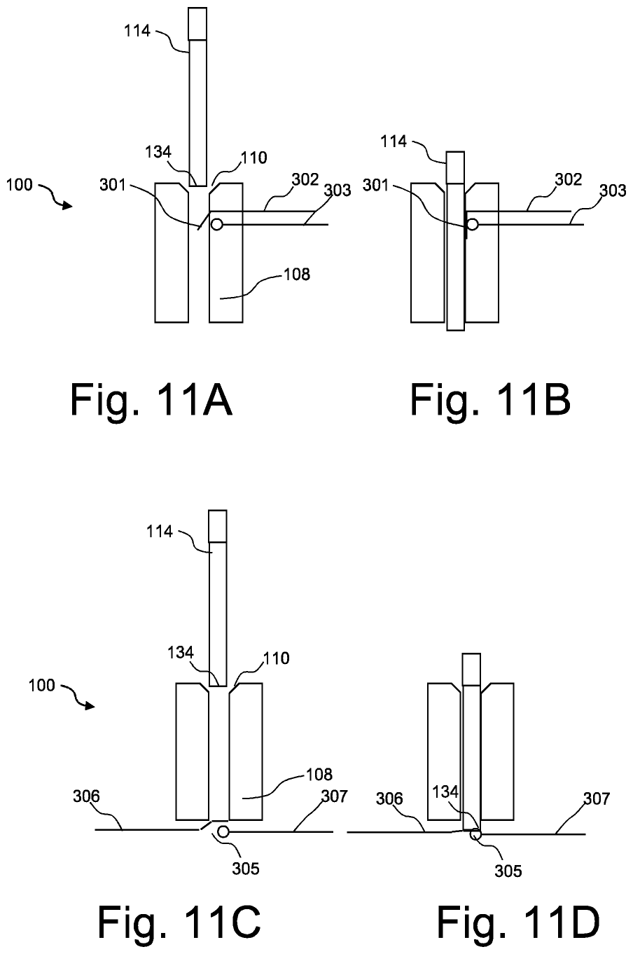

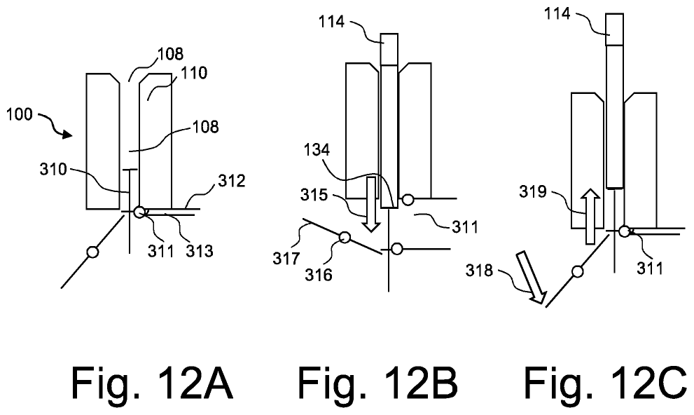

FIGS. 11A to 12C show schematic drawings of different embodiments of an insertion/ejection sensor. The drawings show a portion of an aerosol generation device, in which heat sticks are received. The aerosol generation device may be similar to the device 100 shown in FIGS. 1 to 3. The aerosol generation device 100 shown in simplified form includes the interface 108 (i.e. heating chamber) in which the consumable 114 is received. Within the interface, a switch 301 is provided that is biased towards the open position. The switch 301 is connected via connecting wires 302, 303 to the control circuitry. When the consumable is pushed into the interface 108 through the open end 110, the first end 134 of the consumable 114 closes the switch 301 such that a circuit is closed (see FIG. 11B). As a result, an insertion of the consumable 114 is detected. When the consumable 114 is removed, the switch 301 opens again. Thereby, the removal of the consumable 114 is detected.

A variation of such an insertion/ejection sensor is shown in FIGS. 11C and 11D. Similarly to the switch 301 shown in FIGS. 11A and 11B, a switch 305 is disclosed. The switch 305 is biased towards an open position and connected to the control circuitry with connecting wires 306 and 307. However, the switch 305 is arranged at an end portion of the interface 108 and is only closed, when the consumable 114 has been fully inserted. Thus, an insertion is only detected, once the user has pushed the consumable 114 into its end position as shown in FIG. 11D.

A further variation of an insertion/ejection sensor is shown in FIGS. 12A to 12C. In this embodiment, a piston 310 is arranged in the interface 108. The piston is biased towards the open end of the interface. When the piston is in the position shown in FIG. 12A, i.e. in a first position, a switch 311 connecting wires 312 and 313 is in a closed position. Once the user inserts a consumable 114 as shown in FIG. 12B by arrow 315, the piston 310 is pushed away from the open end no. This opens switch 311 and allows the detection of the insertion of the consumable 114.

The embodiment shown in FIGS. 12A to 12C additionally includes a lever 316 with a pivot 317. The lever 316 is rotatable around the pivot and actuates the piston 311. When a user actuates the lever 317 as indicated by arrow 318, the consumable 114 is pushed out of the interface 108 as indicated by arrow 319. The actuation of the lever 316 causes an electrical contact between wires 313 and 312 by the switch 311 and allows the detection of an ejection of the consumable 114.

1. A method of estimating and indicating a depletion level of a consumable in an aerosol generation device having a processor, a memory and a status indicator, the method comprising the steps of:
generating and storing on the memory usage data on a usage of the aerosol generation device by a user;
reading the usage data from the memory and calculating a depletion level based on the usage data; and
signaling the calculated depletion level of the consumable and/or whether the consumable has been consumed to the status indicator,
wherein the usage data comprises puff records and event records, and
wherein the method further comprises the step of grouping the puff records in sessions based on the event records.

2. The method according to claim 1, wherein the depletion level is calculated in response to a detection of an insertion of a consumable.

3. The method according to claim 1, wherein the usage data comprises at least one of: a number of puffs per consumable, parameters on an airflow of puffs a frequency of puffs, a duration and/or a frequency of usage sessions, or a time of a session.

4. The method according to claim 1, wherein the puff records include at least one of: parameters on an airflow of puffs or a time stamp.

5. The method according to claim 1, wherein the event records include at least one of: a type of event, a type of consumable, a consumable identification number, or a time stamp.

6. The method according to claim 1, further comprising the step of receiving a profile for a type of inserted consumable and calculating a remaining number of puffs additionally based on the type of inserted consumable.

7. The method according to claim 1, wherein the calculation of the depletion level is based on an average number of puffs on previous consumables.

8. The method according to claim 1, wherein the depletion level is calculated or re-calculated based on usage data in response to an activation of the aerosol generation device.

9. The method according to claim 8, wherein the calculation or the re-calculation is based on a time and/or usage data on the immediately preceding session.

10. The method according to claim 1, wherein the depletion level is calculated or re-calculated based on usage data periodically or in response to a detection of a puff, wherein the calculation or the re-calculation uses usage data on the current session.

11. The method according to claim 10, wherein the calculation or the re-calculation compares the usage data to the usage data on past sessions.

12. The method according to claim 1, wherein the depletion level is calculated or re-calculated by calculating a depletion puff number and reducing the depletion puff number by a number of detected puffs after an insertion of the consumable.

13. The method according to claim 1, wherein the step of generating includes generating the usage data with the help of at least one of: a puff sensor, a consumable replacement detector a consumable recognition unit for detecting an identification tag of the consumable, or a user input interface.

14. The method according to one of the preceding claims 1, wherein the depletion level is indicated to a user with a display.

15. Control circuitry comprising a processor and memory, wherein the control circuitry is configured to execute the method according to claim 1.

16. An aerosol generation device having a processor, a memory and a status indicator, and being configured to perform the method according to claim 1, and to indicate the calculated depletion level of the consumable and/or whether the consumable has been consumed by means of the status indicator.

17. The method according to claim 1, wherein the depletion level is a remaining number of puffs on the consumable.

18. The method according to claim 3, wherein the parameters on the airflow of puffs include volume, duration and/or strength.

19. The method according to claim 1, wherein the step of generating includes generating the usage data with the help of at least one of: a consumable replacement detector, including an ejection sensor (251) and/or an insertion sensor.

20. The method according to claim 14, wherein the display is a bargraph, a speaker, or a vibrator.
